(19) United States
(12) Patent Application Publication
(10) Pub. No.: US 2025/0332685 A1
(43) Pub. Date: Oct. 30, 2025

(54) ABRASIVE ARTICLES, SYSTEMS AND METHODS OF USE

(71) Applicant: 3M INNOVATIVE PROPERTIES COMPANY, SaInt Paul, MN (US)

(72) Inventors: Joseph B. Eckel, Vadnaia Heights, MN (US); Ernest L. Thurber, Somerset, WI (US); Blake R. Rustad, Woodbury, MN (US); Thomas J. Nelson, Woodbury, MN (US); Paul Larking, Staffordshire (GB)

(21) Appl. No.: 18/875,611

(22) PCT Filed: Jun. 16, 2023
(86) PCT No.: PCT/IB2023/056281

§ 371 Date: Dec. 16, 2024

Related U.S. Application Data
(60) Provisional application No. 63/366,805, filed on Jun. 22, 2022.

(51) Int. Cl. B24B 49/12

(52) U.S. Cl. CPC B24B 49/12

(57) ABSTRACT

An abrasive article evaluation system is presented that includes a detector that detects a nonvisual abrasive wear cue and an efficiency indication generator that, based on the abrasive wear cue, generates an indication of wear for the abrasive article. The system also includes a command generator that generates a command based in the generated indication of wear.

### BACKGROUND

Coated abrasive articles containing shaped abrasive grains are useful for shaping, finishing, or grinding a wide variety of materials and surfaces such as wood, metals (e.g., especially non-ferrous metals such as aluminum that tend to clog grinding wheels), and flash. There continues to be a need for improving the cost, performance, and/or life of coated abrasive articles.

### SUMMARY

An abrasive article evaluation system is presented that includes a detector that detects a nonvisual abrasive wear cue and an efficiency indication generator that, based on the abrasive wear cue, generates an indication of wear for the abrasive article. The system also includes a command generator that generates a command based in the generated indication of wear.

A robotic abrading system is presented that includes an abrasive article including a wear cue detectable by a sensor, the abrasive article being configured to contact a substrate. The system also includes a robot arm configured to cause the abrasive article to contact the substrate. The system also includes a force control unit, on the robot arm. The force control unit urges the abrasive article into contact with the substrate. The system also includes a wear indication system that determines an amount of wear of the abrasive article based on the wear cue, and, based on the amount of wear, an operational parameter of the robotic abrading system is adjusted.

An abrasive article with a wear cue is presented that includes a bond matrix and a plurality of abrasive particles within the bond matrix. The article also includes a detectable wear indicator that changes after a portion of the service life of the abrasive article has passed.

Described herein are systems and methods for detecting when an abrasive article is nearing the end of its useful life. Some systems and methods herein may improve efficiency of use of abrasive articles as abrasive particles are worn down. However, systems and methods herein are not limited to measuring wear of abrasive particles. It may also be useful to detect wear of a resin matrix, for example in a nonwoven or bonded abrasive article where the entire article wears down during use. Some abrasive articles experience wear of particles and resin down to a backing layer, providing opportunities to visually detect changes.

Some systems and methods herein may be particularly useful for robotic abrading systems, where a human operator is not available to detect the end of life by noticing the change in abrading efficiency. Additionally, some systems and methods herein may be useful for handheld abrasive tools to assist an operator in adjusting use parameters for a tool during an abrading operation.

The above summary of the present disclosure is not intended to describe each disclosed embodiment or every implementation of the present disclosure. The description that follows more particularly exemplifies illustrative embodiments. It is to be understood, therefore, that the following description should not be read in a manner that would unduly limit the scope of this disclosure.

### BRIEF DESCRIPTION OF THE DRAWINGS

FIG. 1 is a top-down schematic of an exemplary coated abrasive article.

FIG. 2 is a schematic cross-sectional view of an exemplary coated abrasive article.

FIG. 3 illustrates a robotic abrading system that may benefit from embodiments herein.

FIG. 4 illustrates a hand held abrading system that may benefit from embodiments herein.

FIG. 5 illustrates an abrasive article evaluation system in accordance with embodiments herein.

FIG. 6 illustrates a method of evaluating abrasive article efficacy in accordance with embodiments herein.

FIGS. 7A-7C illustrate abrasive articles in accordance with embodiments herein.

FIG. 8 illustrates an abrasive article in accordance with embodiments herein.

FIG. 9 illustrates a method of determining an abrading efficiency of an abrasive article in accordance with embodiments herein.

FIG. 10 is a defect inspection system architecture.

FIGS. 11-13 show examples of computing devices that can be used in embodiments shown in previous Figures.

FIG. 14 illustrate an abrasive article core described in the Examples.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

As used herein, the term “shaped abrasive particle,” means an abrasive particle with at least a portion of the abrasive particle having a predetermined shape that is replicated from a mold cavity used to form the shaped precursor abrasive particle. Except in the case of abrasive shards (e.g. as described in US Patent Application Publication Nos. 2009/0169816 and 2009/0165394), the shaped abrasive particle will generally have a predetermined geometric shape that substantially replicates the mold cavity that was used to form the shaped abrasive particle. Shaped abrasive particle as used herein excludes abrasive particles obtained by a mechanical crushing operation. Suitable examples for geometric shapes having at least one vertex include polygons (including equilateral, equiangular, star-shaped, regular and irregular polygons), lens-shapes, lune-shapes, circular shapes, semicircular shapes, oval shapes, circular sectors, circular segments, drop-shapes and hypocycloids (for example super elliptical shapes).

For the purposes of this invention, geometric shapes are also intended to include regular or irregular polygons or stars wherein one or more edges (parts of the perimeter of the face) can be arcuate (either of towards the inside or towards the outside, with the first alternative being preferred). Hence, for the purposes of this invention, triangular shapes also include three-sided polygons wherein one or more of the edges (parts of the perimeter of the face) can be arcuate. The second side may include (and preferably is) a second face. The second face may have a perimeter of a second geometric shape.

For the purposes of this invention, shaped abrasive particles also include abrasive particles comprising faces with different shapes, for example on different faces of the abrasive particle. Some embodiments include shaped abrasive particles with different shaped opposing sides. The different shapes may include, for example, differences in surface area of two opposing sides, or different polygonal shapes of two opposing sides.

The shaped abrasive particles are typically selected to have an edge length in a range of from 0.001 mm to 26 mm, more typically 0.1 mm to 10 mm, and more typically 0.5 mm to 5 mm, although other lengths may also be used.

The shaped abrasive particle may have a “sharp portion” which is used herein to describe either a sharp tip or a sharp edge of an abrasive article. The sharp portion may be defined using a radius of curvature, which is understood in this disclosure, for a sharp point, to be the radius of a circular arc which best approximates the curve at that point. For a sharp edge, the radius of curvature is understood to be the radius of the curvature of the profile of the edge on the plane perpendicular to the tangent direction of the edge. Further, the radius of curvature is the radius of a circle which best fits a normal section, or an average of sections measured, along the length of the sharp edge. The smaller a radius of curvature, the sharper the sharp portion of the abrasive particle. Shaped abrasive particles with sharp portions are defined in U.S. Provisional Patent Application Ser. No. 62/877,443, filed on Jul. 23, 2019, which is hereby incorporated by reference.

In the instance that the abrasive particles are precisely-shaped (e.g., into triangular platelets or conical particles), this effect of orientation can be especially important as discussed in U. S. Pat. Appl. Publ. No. 2013/0344786 A1 (Keipert), incorporated by reference herein. As used herein, the term “alignment” is used to refer to a relative position of an abrasive particle on a backing, while the term “orientation” refers to a rotational position of the abrasive particle at the aligned position. For example, a triangle-shaped particle may have a “tip up” orientation or a “tip down” orientation with respect to the backing.

As used herein, the term shaped abrasive particle refers to a monolithic abrasive particle. As shown, shaped abrasive particle is free of a binder and is not an agglomeration of abrasive particles held together by a binder or other adhesive material.

Described in embodiments here are abrasive articles that include wear indicators or other abrasive efficiency indicators. Some example embodiments are described in the context of particular abrasive article types, such as bonded abrasive wheels or a coated fiber disc. However, it is expressly contemplated that at least some efficiency indicators herein are applicable to multiple types of abrasive articles, and the figures and examples described herein are not intended to be limited.

Additionally, with respect to coated abrasive articles, many examples herein discuss abrasive discs specifically. However, it is expressly contemplated that abrasive belts may also benefit from efficacy indicators described herein.

Further, with respect to bonded abrasive articles, some examples of grinding wheels are described herein. However, it is expressly contemplated that wear indicators suitable for some grinding articles may be suitable for others. Bonded abrasive articles may use vitreous, resin or polymer-based bond matrices. Bonded abrasive structures may include depressed center grinding wheels, cut off wheels, cut-and-grind wheels, precision bonded wheels, cup wheels, segmented grinding wheels, etc. . . .

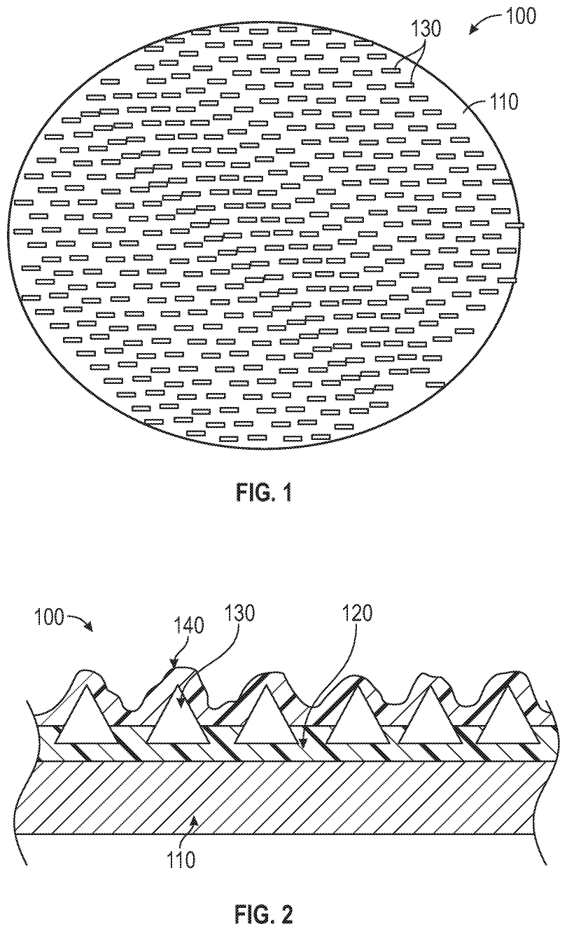

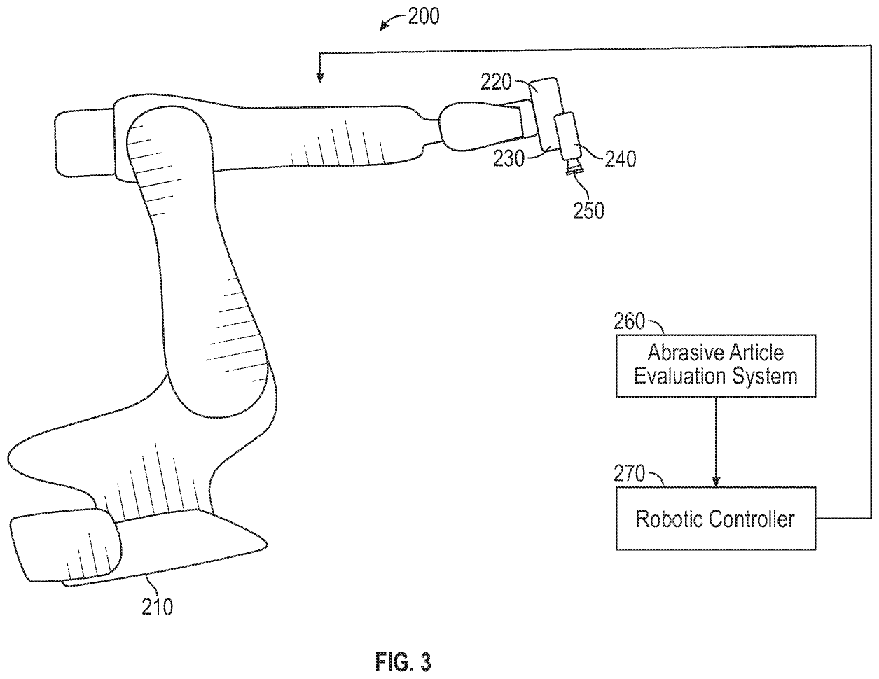

FIGS. 1 and 2 show an exemplary coated abrasive disc 100 according to the present disclosure, wherein shaped abrasive particles 130 are secured at precise locations and Z-axis rotational orientations to a backing 110. In one embodiment, shaped abrasive particles 130 are triangular prism shaped particles that appear rectangular when viewed from above.

Generally, a coated abrasive article 100 includes a plurality of abrasive particles embedded within a make coat that secures the particles to a backing. The backing may be formed from any known flexible coated abrasive backing, for example. Suitable materials for the backing include polymeric films, metal foils, woven fabrics, knitted fabrics, paper, nonwovens, foams, screens, laminates, combinations thereof, and treated versions thereof.

The abrasive particles 130 may be embedded within an abrasive layer, which can include multilayer construction having make 120 and size layers 140. Coated abrasive articles according to the present disclosure may include additional layers such as, for example, an optional supersize layer that is superimposed on the abrasive layer, or a backing antistatic treatment layer may also be included, if desired. Exemplary suitable binders can be prepared from thermally curable resins, radiation-curable resins, and combinations thereof.

Make layer 120 can be formed by coating a curable make layer precursor onto a major surface of backing 110. The make layer precursor may include, for example, glue, phenolic resin, aminoplast resin, urea-formaldehyde resin, melamine-formaldehyde resin, urethane resin, free-radically polymerizable polyfunctional (meth)acrylate (e.g., aminoplast resin having pendant α,β-unsaturated groups, acrylated urethane, acrylated epoxy, acrylated isocyanurate), epoxy resin (including bis-maleimide and fluorene-modified epoxy resins), isocyanurate resin, and mixtures thereof. Of these, phenolic resins are preferred.

Phenolic resins are generally formed by condensation of phenol and formaldehyde, and are usually categorized as resole or novolac phenolic resins. Novolac phenolic resins are acid-catalyzed and have a molar ratio of formaldehyde to phenol of less than 1:1. Resole (also resol) phenolic resins can be catalyzed by alkaline catalysts, and the molar ratio of formaldehyde to phenol is greater than or equal to one, typically between 1.0 and 3.0, thus presenting pendant methylol groups. Alkaline catalysts suitable for catalyzing the reaction between aldehyde and phenolic components of resole phenolic resins include sodium hydroxide, barium hydroxide, potassium hydroxide, calcium hydroxide, organic amines, and sodium carbonate, all as solutions of the catalyst dissolved in water.

Resole phenolic resins are typically coated as a solution with water and/or organic solvent (e.g., alcohol). Typically, the solution includes about 70 percent to about 85 percent solids by weight, although other concentrations may be used. If the solids content is very low, then more energy is required to remove the water and/or solvent. If the solids content is very high, then the viscosity of the resulting phenolic resin is too high which typically leads to processing problems.

Phenolic resins are well-known and readily available from commercial sources. Examples of commercially available resole phenolic resins useful in practice of the present disclosure include those marketed by Durez Corporation under the trade designation VARCUM (e.g., 29217, 29306, 29318, 29338, 29353); those marketed by Ashland Chemical Co. of Bartow, Florida under the trade designation AEROFENE (e.g., AEROFENE 295); and those marketed by Kangnam Chemical Company Ltd. of Seoul, South Korea under the trade designation PHENOLITE (e.g., PHENOLITE TD-2207).

The make layer precursor may be applied by any known coating method for applying a make layer to a backing such as, for example, including roll coating, extrusion die coating, curtain coating, knife coating, gravure coating, and spray coating.

The basis weight of the make layer utilized may depend, for example, on the intended use(s), type(s) of abrasive particles, and nature of the coated abrasive article being prepared, but typically will be in the range of from 1, 2, 5, 10, or 15 grams per square meter (gsm) to 20, 25, 100, 200, 300, 400, or even 600 gsm. The make layer may be applied by any known coating method for applying a make layer (e.g., a make coat) to a backing, including, for example, roll coating, extrusion die coating, curtain coating, knife coating, gravure coating, and spray coating.

Once the make layer precursor is coated on the backing, the triangular abrasive particles are applied to and embedded in the make layer precursor. The triangular abrasive particles are applied nominally according to a predetermined pattern and Z-axis rotational orientation onto the make layer precursor. Using known orientation methods, such as electrostatic or magnetic orientation, it is possible to orient the abrasive particles with respect to the backing in order to improve performance of the particles.

However, while FIGS. 1-2 illustrate a coated abrasive article, it is expressly contemplated that systems and methods herein may also be suitable for understanding use and wear of other abrasive articles such as bonded abrasive articles with resin or vitreous bond matrices, nonwoven abrasive articles, brushes, or other abrasive articles.

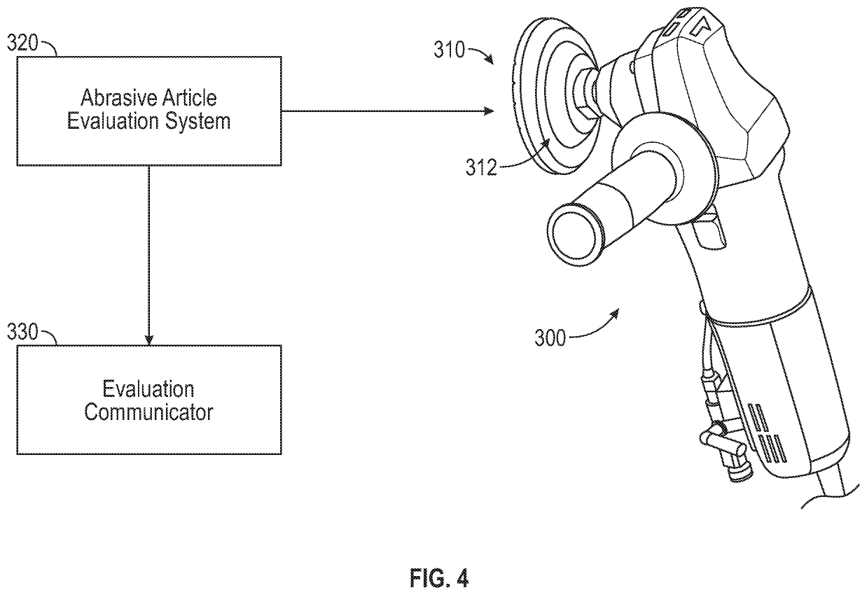

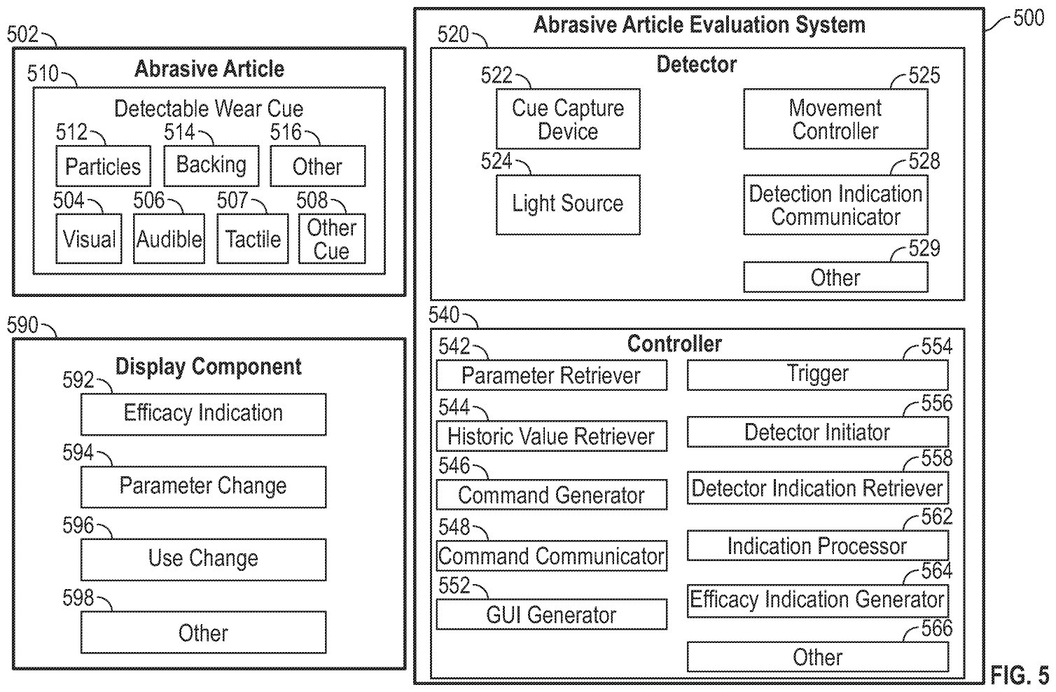

Abrasive articles may be used in a number of contexts. Described herein are the robotic repair context (FIG. 3) and the handheld tool context (FIG. 4). Different use scenarios of abrasive articles present different problems regarding article use over time. For example, an experienced human operator can often “feel” when an abrasive article is losing cut efficacy overtime and adjust accordingly, by applying more force or adjusting an angle. Similarly, an abrasive article may maintain an acceptable abrasive efficacy, but be close enough to an end of life that it needs to be replaced. A robotic system may have no insight into the wear or loading occurring on an abrasive article and may not make necessary adjustments or replace an abrasive article when needed. Systems and methods herein may be useful in other contexts as well.

FIG. 3 is a schematic of a robotic arm that may benefit from embodiments disclosed herein. A robotic repair unit 200 has a base 210, which may be stationary, in some embodiments. In other embodiments, base 210 can move in any of six dimensions, translations or rotations about an x-axis, y-axis and/or z-axis. For example, robot 200 may have a base 210 fixed to a rail system configured to travel along with a moving substrate being repaired. Depending on a particular operation, robot 200 may need to move closer, or further away from a substrate, or may need to move higher or lower with respect to an abrading area. A moveable base 200 may thus increase functionality.

Robotic arm unit 200 has one or more tools 240 that can interact with a worksurface. Tool 240 may include a backup pad 250, in one embodiment, or another suitable abrasive tool. During an abrasive operation, tool 240 may have an abrasive disc, or other suitable abrasive article, attached using adhesive, hook and loop, clip system, vacuum or other suitable attachment system. However, as the abrasive article moves in conjunction with a backup pad 250 to which it is attached, the abrasive article is not necessarily considered as adding additional degrees of freedom to the movement of robotic repair unit 200. As mounted to the robotic repair unit 200, tool 240 has the ability to be positioned within the provided degrees of freedom by the robotic repair unit 200 (6 degrees of freedom in most cases) and any other degrees of freedom (e.g., a compliant force control 230 unit).

Backup pad 250 is coupled to a tool 240 which has an orbit that provides some additional degrees of freedom. In most tools a single degree of freedom is provided by a rotating shaft with or without some offset. Tool 240 is coupled to the output of a force control unit 230. Force controlled flange 230 provides a soft (i.e., not stiff) displacement curve. In most force control units, a single degree of freedom is provided by a sliding (prismatic) joint along the active axis. Force control 230 is coupled to a flange 220. Movement of components 210, 220, 230, 240 and 250 is all controllable using a robot controller (e.g., robot controller 270).

Robotic controller 270, in addition to moving components 210-250 based on the parameters of an abrading operation, may also adjust parameters based on information received from an abrasive article use evaluation 260. For example, if evaluation system 260 indicates that an abrasive article has reached an end of life, controller 270 may instruct system 200 to stop an abrading operation, change out the old abrasive article for a new abrasive article, and then continue an abrading operation. Additionally, for example, controller 270 may provide new parameters for abrading based on the feedback from system 260. For example, if an abrasive article loaded, controller 270 may increase a coolant flow to flush accumulated swarf. If the abrasive article is capped, controller 270 may initiate a dressing process to alleviate detected capping. If the abrasive article is worn, but not at end of life, controller may increase a force applied by force control unit 230, or may adjust an angle of tool 240 with respect to a substrate. Such adjustments are described in greater detail with reference to later figures.

FIG. 4 illustrates a hand tool 300 that may be used by a human operator during an abrading operation. Tool 300 includes an abrasive article 310 coupled to a backup pad 312. Tool is maneuverable by a human operator such that an angle of the abrasive article 310 is adjustable. An applied force may also be adjustable, for example by a human operator leaning into an operation.

While experienced human operators may be able to adjust operational conditions based on a “feel” of the abrading operation, at least some operators may benefit from an evaluation system 320. Abrasive article evaluation system 320 may detect use conditions of abrasive article 310 and evaluation communicator 330 may communicate a wear condition or operating condition of the abrasive article to the human operator. For example, tool 300 may include a display that provides instructions for a human operator—e.g. based on an internal gyroscope or accelerometer the tool may guide the user into adjusting an angle of the tool with respect to a surface. In other embodiments, communicator 330 may display results, instructions or suggestions on a display associated with the human operator—such as a display on protective gear worn by the user (e.g. a heads up display or an augmented reality overlay provided on safety glasses) or on a display in the area. Communicator 330 may also communicate results in another manner, such as audibly, or just by indicating that the abrasive article is acceptable for continued use or unacceptable for continued use.

Described herein are systems and methods for evaluating an abrasive article. The abrasive article may be associated with a robotic abrading system, like that illustrated in FIG. 3, or may be a human operated tool, like that illustrated in FIG. 4. Evaluating the abrasive article is broadly used to refer to evaluating a parameter related to abrasive efficiency of the abrasive article. Abrasive efficacy may be affected by wear—as the article is used and the particles ground down, the cut rate decreases. However, abrasive efficacy can also be affected by other factors that may be detectable using systems and methods herein. For example, capping or loading may occur, causing abrasive particle tips to be covered and unavailable for abrading. Other efficacy factors may also be detectable.

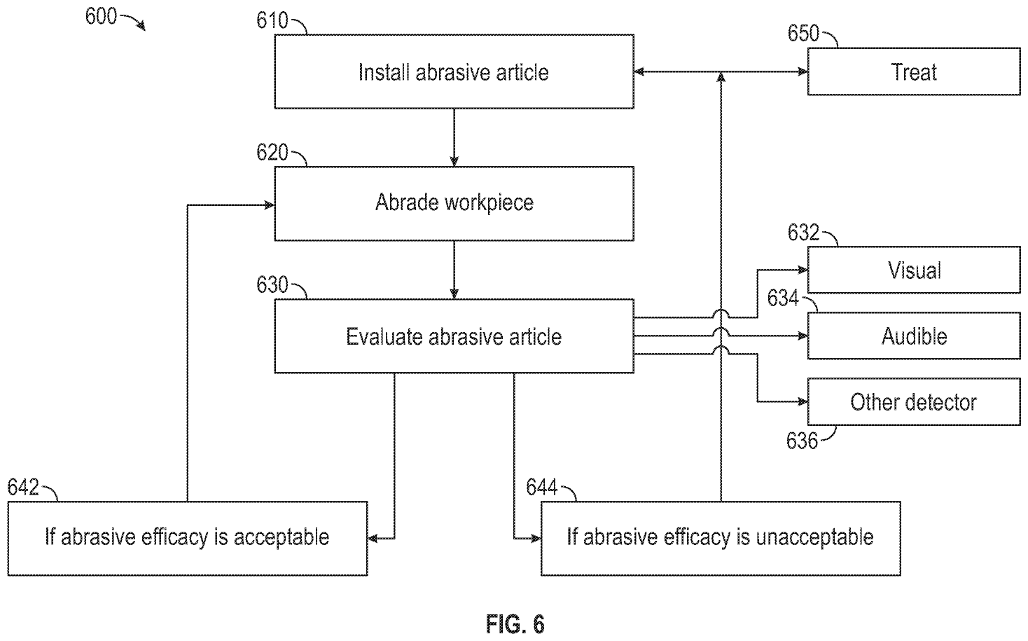

FIG. 5 illustrates an abrasive article evaluation system in accordance with embodiments herein. Abrasive article evaluation system 500 is suitably accessible for an abrasive article 502. For example, a robotic arm may move an abrasive article 502 in range of detector 502 with a cue capture device 522. In some embodiments herein, cue capture device 522 is a camera or other image capturing component that images the abrasive article 502. In other embodiments, cue capture device 522 is a sensor that captures another signal, such as a sound, a vibration, a weight, a thickness or another parameter of abrasive article 502 as described in embodiments herein. In embodiments where cue capture device 522 is a camera, detector 520 may also have a light source 524. The light source may provide illumination in the visual spectrum, ultraviolet spectrum, infrared spectrum or another wavelength suitable for detecting cue 510.

As described herein, an abrasive article 502 includes a cue 510 that can be detectable by a sensor 522. The cue may be incorporated into particles 512 within abrasive article 502, a backing 514 or resin structure, or another component 516 of the abrasive article. The detectable cue 510 may be a visual indication 504, an audible indication 506, or another cue 508. For example, cue 510 could be a detectable weight loss or shrinkage of an abrasive article 502 that is detectable by a scale or calipers.

In some embodiments herein, the cue is detectable by an operator holding a tool coupled to the abrasive article, such that a tactile change 507 is detected as the abrasive article nears the end of its service life. In the robotic context, a tactile change 507 may be detectable by a force control unit or an accelerometer.

Detector 520 may be stationary, such that a robotic arm or a human operator brings abrasive article 502 into range of cue capture device 522. In other embodiments, detector 520 is mobile, with a movement controller 525 that can move cue capture device 522, light source 524 or other component 529 into position to detect cue 510. Detector 520 may communicate a signal generated by cue capture device 522 using a detection indication communicator 528. However, it is expressly contemplated that, while detector 520 is illustrated in FIG. 5 as separate from a controller 540 that completes an evaluation, they may be a single component in some embodiments.

Controller 540 receives a detection indication from detector 520 using a detector indicator retriever 558. Detection indicator retriever 558 may request an indication from detector 520, in response to a detector initiator 556, which may send a command to detector 520 to actuate cue capture device 522. A trigger 554 may cause detector initiator 556 to actuate, in some embodiments. For example, a motion detector 554 may detect that abrasive article 502 has moved into position. Trigger 554 may also be time or position based.

Indication processor 562 processes the received signal from detector 520. As described herein, that may include comparing the received signal to a threshold, reviewing it against a historic signal value retrieved from a datastore by historic value retriever 544, or otherwise processing the signal to determine whether an abrasive efficacy of article 502 has reached an undesired low or determine if abrasive article 502 is near the end of life and will need to be changed soon.

Indication process 562 may use a threshold that is set by a manufacturer, a customer, an operator, a shift supervisor, etc. For example, one customer may set a lowest acceptable thickness of an abrasive disc as T while a second sets the threshold at 2T.

In some embodiments, controller 540 may determine that, while an abrasive efficacy has dropped below a threshold, it may be possible to improve by altering one or more operational parameters. Parameter retriever 542 may retrieve a current set of operating parameters—such as an applied force from a force control unit, an abrading angle from an accelerometer, etc. A command generator 546 may generate a command, for example to a robot arm controller to adjust an applied force or angle, which is then communicated to the robot arm controller, using command communicator 548. Command generator 546 may also generate a command to exchange abrasive article 502 for a new abrasive article, or to re-dress abrasive article 502 to remove loading or metal capping. Metal capping occurs when metal adheres to an abrasive grain, for example due to excessive heat and/or insufficient pressure. Metal capping prevents an abrasive particle from fracturing, which allows the abrasive particle to resharpen itself. In some embodiments, command generator 546 and command communicator 548 may operate automatically, such that a robot controller is continuously adjusting parameters to improve abrading efficacy.

An efficacy indication generator 564 generates an indication of an abrading efficacy of abrasive article 502. The indication may be displayed, for example on a display component 590. The indication may be provided in words, e.g. “60% used” or “capping detected” or may be provided as a simple “good” or “bad.” The indication may be audible, e.g. an alarm or signal indicating that action is needed to improve the abrading efficacy or to replace abrasive article 502. The indication may be provided to a graphical user interface generator 552, which may generate an interface for display component 590. Controller 540 may also have other functionality 566.

Display component 590 may be incorporated into a hand tool, in some embodiments, such that an efficacy indication 592 is visible to a user of the hand tool. In other embodiments, display component 590 is separate from a tool. For example, in a robotic abrading context, display component 590 may be separate from a robotic arm, but visible to an operator. In some embodiments, display component 590 is part of a mobile computing device, such as an operator's mobile phone or tablet. GUI generator 552 may then send an indication to an application running on the device, such that efficacy indication 592 can be updated.

Display component 590 may also present a parameter change 594, such as an adjustment of a tool angle, an increase or decrease in applied force, etc. A use change 596 may also be indicated. For example, a coated abrasive article that has experienced significant wear may no longer be appropriate for an initial high-volume abrading removal step of a process, but may be suitable for a later, lower-volume abrading removal step. Display component 590 may also provide other information 598, received from controller 540, detector 520 or elsewhere. For example, a unit count of parts completed, an average abrading time, or other relevant information may be displayed.

System 500 is illustrated as separate from display component 590 in FIG. 5, however it is expressly contemplated that a single computing unit may include display component 590 and some or all of the components of system 500. For example, detector 520 and controller 540 are illustrated as part of a single unit, it is expressly contemplated that at least some components may be part of separate devices. For example, controller 540 may be part of a robotic arm controller, a separate computing device remote from detector 520 and display component 590.

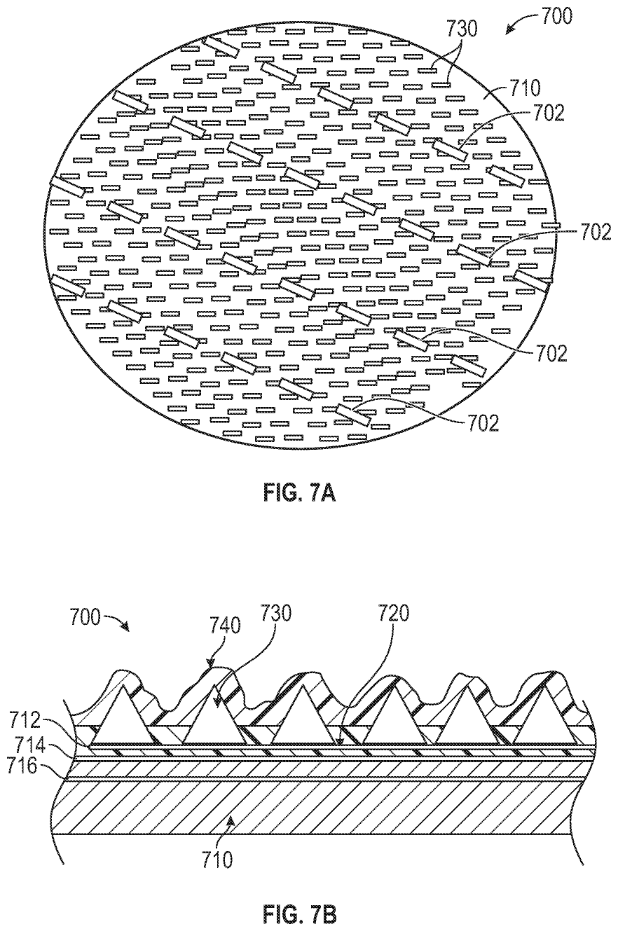

FIG. 6 illustrates a method of evaluating an abrasive article. In some embodiments, evaluating may be automatically completed using method 600. For example, a robotic arm or a human operator may move an abrasive article within range of, or past, a detector which may capture a signal indicative of abrading efficacy of the abrasive article.

In block 610, an abrasive article is installed on a tool. For example, the abrasive article may be coupled to a backup pad on a hand held abrasive tool or to a tool of a robotic abrading unit. The abrasive article may be any suitable abrasive article for a given abrading operation, such as a coated abrasive article, a bonded abrasive article, a bristle brush, a nonwoven abrasive article, or another suitable abrasive article.

In block 620, the abrasive article engages a workpiece and an abrading operation is conducted. As the workpiece is abraded, abrasive particles of the abrasive article experience wear. They may also experience capping, loading or other degradation.

In block 630, the abrasive article is evaluated. An abrading efficacy of the abrasive article is determined. A visual cue 632 may be analyzed to detect wear, capping or loading, in some embodiments. An audible cue 634 may be analyzed to detect wear, capping or loading. In other embodiments, a different detector 636 detects a cue of abrasive efficacy.

Evaluating the abrasive article may be done by directly measuring a parameter of the abrasive article, such as visual indicia, sounds, or other indicia of the abrasive article during or after an abrasive operation. In other embodiments, evaluating the abrasive article may be done by evaluating the workpiece, swarf removed from the workpiece, or another component.

Evaluation, in block 630, may be done automatically as part of an abrading process. For example, a robotic arm coupled to the abrasive article may change positions, for example while a completed workpiece is replaced by a new workpiece, such that the abrasive article is within range of a detector. Similarly, a human operator may set down an abrasive tool coupled to the abrasive article in a position within range of a detector while the human operator changes out a part to be abraded or completes another task.

In block 642, if the abrasive efficacy of the abrasive article is still at an acceptable level, then it can continue to be used for another abrasive operation. In some embodiments, new operational parameters are provided based on a detected decrease in abrasive efficacy between evaluations. In a robotic abrading operation, the new parameters may be automatically implemented. In a handheld tool context, the new parameters may be suggested to an operator.

In block 644, if the abrasive efficacy is below an acceptable level, it can either be treated, as indicated in block 650, for example by dressing the abrasive article to remove capping, washing or cleaning the abrasive article to remove loading. However, in some embodiments, method 600 returns to block 610.

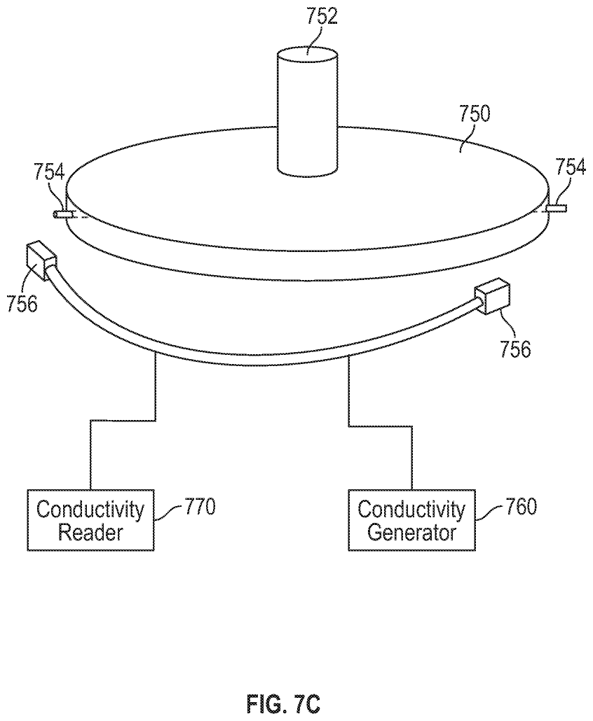

Described herein in FIGS. 7-12 are examples and embodiments of the present invention where a detected indication of abrasive efficacy are visual in nature. However, it is expressly contemplated, and described in co-pending applications 63/366,803 and 63/366,802, both filed on Jun. 22, 2022, that other abrasive efficacy cues are possible.

FIGS. 7A and 7B illustrate abrasive articles in accordance with embodiments herein. FIG. 7A illustrates a top-down view of an abrasive disc, and FIG. 7B illustrates a cut-away view of the same abrasive disc. However, while an abrasive disc is illustrated, it is expressly contemplated that embodiments herein can be incorporated into nonwoven or bonded abrasive articles as well.

Abrasive disc 700 includes abrasive particles 730 embedded in a resin layer 720 on a backing 710. A second resin layer 740 covers abrasive particles 730. As illustrated, a number of low electrical resistance pathways 702 extend through the abrasive article. The pathways extend across the abrasive article, in one embodiment, such that significant wear on the edge or center of the surface of article 700 will cause the pathway(s) to be exposed and/or broken. A low electrical resistance pathway may be a wire, for example, or a line of metal paste printed or dispensed onto a disc. The metal past could be copper, aluminum or another suitably conductive material. Additionally, in some embodiments, an anti-seize material may be used (e.g. a material used for preventing galling of a substrate). Wires may extend past the edges of an abrasive article, in some embodiments, such that continuity can be readily checked. As illustrated in FIG. 7B, a number of placement options may be suitable, depending on the abrasive operation. For example within the make coat 712, at an interface 714 between the backing and the make coat, or within backing 710, as illustrated by position 716. However, it is expressly contemplated that, in some embodiments, low conductivity pathways are placed in only one of positions 712, 714, 716. Other positions within an abrasive article may also be suitable. While low conductivity pathways 702 are illustrated in FIG. 7A as parallel and equally spaced across a surface of the abrasive article. However, it is expressly contemplated that other arrangements are possible. It may be preferred, for some abrasive operations, to have one or more low conductivity pathways 702 extend through the center of the abrasive article. It may be preferred for a wire to have a length that winds through the article, e.g. in a zig-zag or curved pattern. It may be preferred for the low conductivity pathways to be placed in concentric circles so that feedback is available for where a discontinuity occurred. This may be helpful in estimating an available bearing area, and for providing feedback for the next operation. For example, if a broken wire is detected in a middle area of an abrasive disc, a recommendation may be made to an operator, or a command sent to a robotic operating system, to change an angle of contact to utilize the edge area of the disc instead. This may help ensure that an abrasive article is fully used before being discarded. However, it is also desired for conductivity to be easily checked. Therefore, in some embodiments, a wire or other low conductivity pathway extends past an edge of the abrasive article, or protrudes through a backing of the abrasive article such that continuity can be easily checked.

In embodiments where a backing 710 is multilayered, the low conductivity pathways may be embedded within the backing as part of the construction process. It may also be preferred, in some embodiments, to have wires embedded in different layers of the abrasive article, to provide several different indications of wear as different wires are exposed and broken.

While coated abrasive articles are discussed, it is also expressly contemplated that a low conductivity pathway may be used to detect wear in other abrasive articles. For example, embedding a low conductivity pathways at different radial depths of a bonded abrasive article may be useful for maintaining a constant abrading speed. For example, grinding wheels are often run at a constant rpm such that a new grinding wheel, with a longer radius, has a surface area traveling at a faster rate than a worn grinding wheel, with a smaller radius. As different low conductivity pathways are exposed and broken, a radius of the grinding wheel can be inferred and a rotational speed can be increased to maintain a constant speed of surface area contact between the grinding wheel and a substrate. Similar techniques may be used for other abrasive articles with changing radii, such as abrasive brushes or nonwoven convolute wheels, etc.

Low conductivity pathways 702 may have a voltage applied to them during an abrasive operation, or between successive abrasive operations, the voltage going from a source to a receiver. The voltage received is measured over time such that a discontinuity is detected. In some embodiments, the voltage is measured continuously when the abrasive article is in contact with a substrate. When a discontinuity is detected, an alarm may sound, in some embodiments, to indicate to an operator that a wear threshold has been reached. A low conductivity pathway 702 may be made from any suitably conductive material, such as aluminum, silver, gold, zinc, brass, nickel, etc. Conductivity may be measured using a receiving device, in some embodiments that contacts a portion of pathway 702 extending to, or beyond, the edge of an abrasive article, for example as illustrated more clearly in FIG. 7C.

FIG. 7C illustrates an abrasive article 750 with a low conductivity path 754 extending therethrough. A spindle 752 may couple abrasive article 750 to a handheld abrasive tool or to a robotic abrading unit. The abrasive article 750 can be brought into proximity to a current or voltage generating device 760 that, when conductivity path 754 is intact, produces a result at conductivity reader.

In the handheld abrasive tool context, a user may set a grinding tool down in a stand that incorporates electrodes 756, such that electrodes 756 couple to low conductivity path ends 754. A user may set the grinding tool down in between parts of an abrasive operation, for example to wipe away accumulated debris, polish, fluids, etc.

In a robotic abrading system context, electrodes 756 may be positioned on a robotic unit such that abrasive article 750 comes into a position for path ends 754 to contact electrodes 756 at some point during an abrasive operation cycle. For example, on a two-headed tool design like that described in U.S. patent application . . . with Ser. No. 17/779,218, filed on Nov. 24, 2020. may have electrodes 756 positioned such that, when a second tool is in use, abrasive article 750 contacts leads. Abrasive article 750 may also contact electrodes 756 while rotating into, or out of, a use position.

It is also contemplated that a robotic arm may maintain an active position of abrasive article 750 (e.g. in an orientation to contact a workpiece) and, at some point during an abrasive operation cycle, move abrasive article 750 such that path ends 754 contact electrodes 756. For example, a robotic arm 750 may move abrasive article 750 into position while a wiping operation is ongoing, such that no additional cycle time is added to determine whether pathway 754 is still intact. However, it is also contemplated that a conductivity or voltage may be measured in between abrasive operation cycles.

The wire may be any suitably conductive material, and the voltage a suitable amount to generate a detectable resistance without risking damage to the abrasive article. For example, a copper wire, which is a soft metal, may suitably bend during use without breaking. When the wire is unbroken, the resistance will a very low conductivity, and when the wire breaks, the resistance rapidly increases, which can trigger an alarm.

While a coated abrasive disc is illustrated in FIGS. 7A-7C, it is expressly contemplated that wires may be inserted into abrasive belts as well as nonwoven or bonded abrasive articles, so long as a voltage or current can be detectably run through the wire. Additionally, some metals, like copper, may be suitably malleable that they can be used in a nonwoven abrasive article without breaking.

In some embodiments, instead of voltage, dissimilar metals are used and a current is run across the disc to measure a temperature of the abrasive disc. If the temperature passes a threshold temperature, an alarm may be triggered. Temperature of the abrasive article increases as abrasive particles are worn down and more area of the abrasive article is in contact with the substrate, creating more friction.

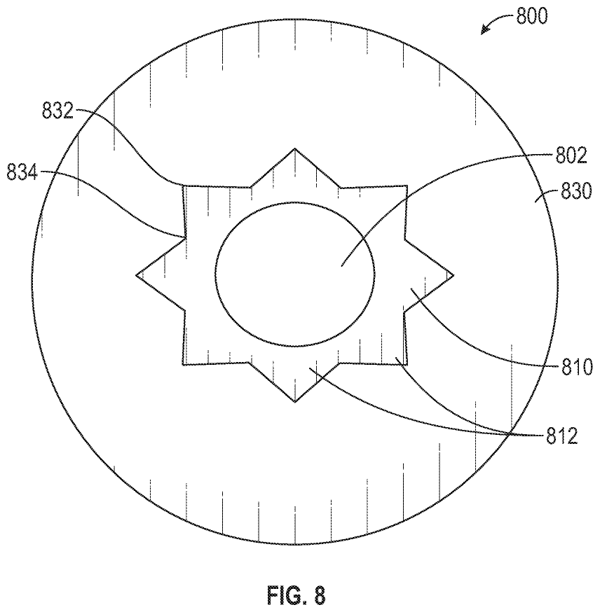

FIG. 8 illustrates a cross section of an abrasive article in accordance with embodiments herein. The illustrated cross section is of an abrasive wheel 800 with a center hole 802, which may receive a tool spindle for example. Wheel 800 also includes a shaped core 810. Shaped core 810 may have threading along the edge of the centerhole to receive a tool spindle. Wheel 800 is a convolute abrasive wheel, formed of a nonwoven abrasive article wound multiple times about a core. Wheel 800 may be suitable for abrasive finishing or deburring.

As illustrated in FIG. 8, core 810 includes features 812 that result in an uneven outer surface of the core, and a difference in thickness of an abrasive layer 830, from a minimum thickness 832 and a maximum thickness 834. Because nonwoven material is compressible, this results in a difference in density near the core at minimum thickness (lower density) and maximum thickness (higher density). This difference in density causes vibrations that may become detectable, or increase in intensity, as wheel 800 is worn down.

However, it is also contemplated that bonded abrasive articles may also benefit from an irregular core shape. For example, using core 810 in a bonded abrasive article, will result in a detectable vibration or sound as it is exposed and contacts the substrate, as core 810 has a different composition and density than a bond matrix. Core 810 may have different features 812 when used in a bonded abrasive article, such as longer extending protrusions that radiate out from the core so that features 812 are visible as wear occurs past a certain point. Core 810 may have features 812 that are differently colored from a bond matrix so that they are visually detectable. While features 812 are illustrated as extending uniformly along a length of core 810, it is expressly contemplated that features 812 may only extend partway along the length of core 810. This may be useful for bonded abrasive articles to ensure integrity is maintained as features 812 are exposed.

The vibrations provides an indication that the end of service life is near. The difference in thicknesses 832 and 834 can be adjusted, depending on how much warning is needed for a given operation, by selecting an abrasive wheel 800 with the desired differential thickness.

Features 812 are illustrated as triangular protuberances extending from a ring-shaped core. However, it is expressly contemplated that features 812 may be any suitable shape—such as semi-circular, square, rectangular, sinusoidal, etc. Similarly, there may be any suitable number of features 812. It may be suitable to only have one feature 812, particularly in the robotic abrading context where sensors may be fine enough to detect the change in rhythm of the abrasive contact.

For a human operator, the exposure of cure features 812 will cause the grinding process to go from a smooth feel to a bumpy feel. Similarly, a distinction may be detectable if a lower layer of a bonded abrasive article has a different particle density, or smaller patterned particles. If chatter is introduced, a different sound, feel or signal will be generated during the abrading operation.

Additional benefits may be provided by adding features to a core 810, such as increased adhesion between the core and the abrasive layer.

While a core 810 is illustrated, it is expressly contemplated that a scrim layer with suitable embossed features may provide a similar indication.

A similar concept may apply to nonwoven or coated abrasive articles by having embossing on the surface of the backing, such that the feel of the abrading tool changes as the end of use is near.

As mentioned with respect to FIG. 8, a sound may detectably change as an abrasive article is used. For example, arrangement of particles can impact the sound profile of an abrading operation. It may be possible, therefore, to train an acoustic sensor to measure use based on auditory sound. For example, an abrasive disc or belt with backfill in between shaped abrasive grains may sound different as the taller abrasive grains are ground down to the level of the backfill particles and the backfill particles engage the substrate surface.

Backfill, or filler particles, may be selected to change the pitch or tone of the abrasive operation in a detectable way. In some embodiments, the change is detectable to a human ear as a tonal change. However, in other embodiments the change is either not large enough for human detection, or outside the range of human hearing. Therefore, an auditory sensor may be placed in the vicinity of the abrading operation to detect the change in sound. When detected, the sensor may trigger an alarm or an alert about the amount of life remaining. Chinese Patent Publication CN105345663 describes one suitable acoustic emissions sensor, however other suitable options are possible.

Other sound changing options are also possible. For example, a material may be inserted that, when it contacts a particular substrate, produces a squeal. For example, steel ball bearings may be added to a make layer of a coated abrasive. As the steel particles contact a metal workpiece, the sound will change from the normal tone of the abrasive grinding to a substantially different pitch or tone that can be detected. As the steel particles contact a metal workpiece, the sound will change from the normal tone of the abrasive grinding to a substantially different pitch or tone that can be detected.

Similarly, in abrasive wheel articles, an auditory warning tab may be placed a a specified diameter such that when the wheel is worn down to that diameter, the warning tab will contact the metal substrate and impart a substantially different auditory pitch or tone that can be detected.

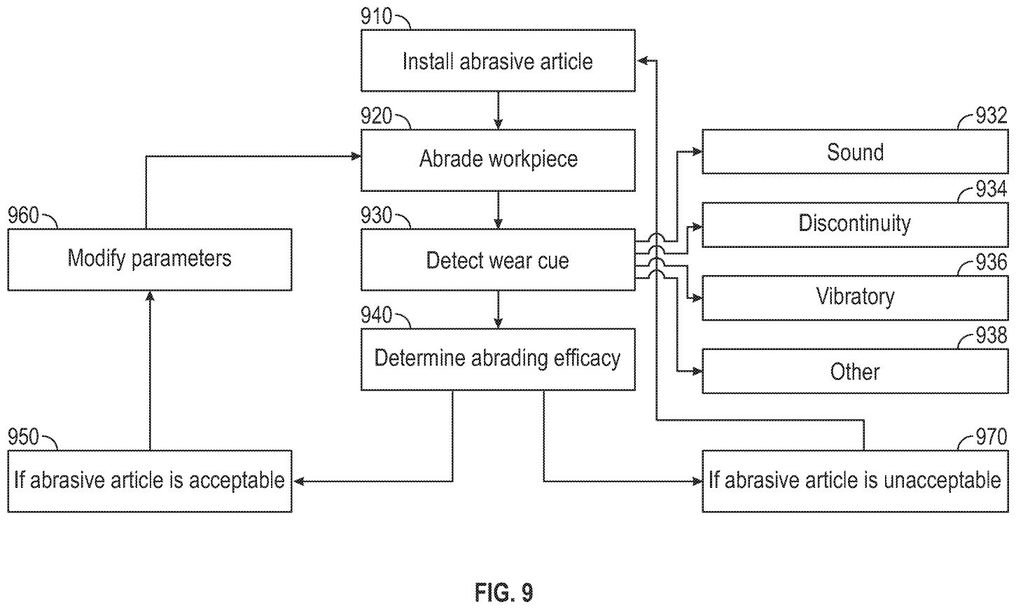

FIG. 9 illustrates a method of abrading a substrate in accordance with embodiments herein. Method 900 may be used to determine an amount of wear of an abrasive article during it service life.

In block 910, an abrasive article is installed on a tool. The tool may be hand-powered tool or a robotic abrading unit. The abrasive article may be a bonded abrasive article, with a resin, vitreous or polymer-based bond matrix, in some embodiments. In other embodiments, the abrasive article is a disc, belt or pad containing abrasive particles. The abrasive article also contains a wear indicator within its structure that provides a detectable wear cue at some point during the service life of the abrasive article. The wear cue may indicate that the abrasive article is completely used, nearing the end of its service life, or another point. For example, the wear cue may indicate that the abrasive particle is 25% used and now additional force must be applied to maintain abrasive efficacy.

In block 920, a workpiece is abraded with the abrasive article. As the abrasive article abrades the surface, abrasive particles are ground down, or fracture.

In block 930, after a certain amount of wear, a sensor detects a wear cue. In embodiments where the wear cue is a sound 932, the sensor is an auditory emission detector. For example, a decibel level of sound may increase or decrease, or a pitch or tone may increase or decrease as the article experiences wear. A discontinuity 934 may be detected, using a voltage meter or current detector, when a wire extending through a portion of the abrasive article breaks. The wire may extend through a layer of the abrasive article and become exposed, and eventually break or wear through, in response to use. The wear cue may also be a change in abrading rhythm of the abrasive article against the substrate, an increase in vibrations 936 detectable by a human operator, an accelerometer, a force control unit, or another suitable sensor. Other wear cues 938, or a combination of wear cues, may be present.

In block 940, the detected wear cue is used to determine an abrading efficacy of the abrasive article. The detected wear cue may be an alarm indicating that the abrasive article is spent and needs to be replaced. In such cases, the abrasive article is deemed unacceptable and, as illustrated in block 970, a new abrasive article is installed.

However, in some embodiments, a number of wear cues are present within an abrasive article, or a single wear cue may change over time, such as sound produced by abrasive particles as they are further ground down, or other particles are exposed. A first detected wear cue may indicate that the abrasive article can still be used, as indicated in block 950, but operational parameters may be modified to increase abrading efficacy, as indicated in block 960. For example, an outer area of an abrasive article may be spent, and the wear indicator may trigger a change in attack angle of the abrasive article with respect to a substrate.

Described herein are systems and methods for detecting wear in abrasive articles. The abrasive articles, as described herein, may be grinding wheels with a vitreous, resin, or polymer-based bond matrix. For example, the grinding wheel may be a depressed center grinding wheel, cut-off wheel . . . . The abrasive article may also be a coated abrasive article, such as a fiber backed disc or woven fabric backed belt with abrasive particles attached thereto through a resin layer. The abrasive article may include a nonwoven layer, either as a backing or impregnated with abrasive particles.

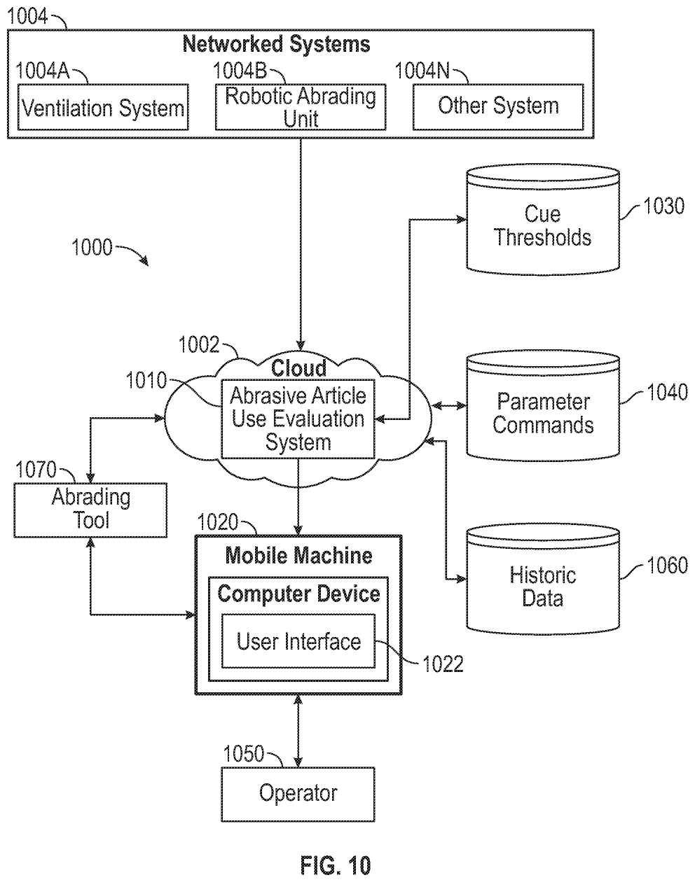

FIG. 10 is a networked architecture for an abrasive article use evaluation system 1010. Architecture 1000 illustrates one embodiment of an implementation of a system 1010, however others are possible. In various embodiments, remote servers can deliver the services over a wide area network, such as the internet, using appropriate protocols. For instance, remote servers can deliver applications over a wide area network and they can be accessed through a web browser or any other computing component.

Software or components, as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided by a conventional server, installed on client devices directly, or in other ways.

As described herein, based on an indication from abrasive article use evaluation system 1010, a robotic abrading unit 1004B, in response to a command received over a wired or wireless network (e.g. retrieved from commands datastore 1040), may adjust a force or speed or another parameter relevant to an abrasive operation.

Knowing when an abrasive article is nearing an end-of-life may allow for improved environmental health and safety for workers in the immediate environment, in addition to improved efficiency benefits to the abrasive operation. For example, it is known that more dust is produced near the end of life of an abrasive article than at the beginning. Knowing whether an abrasive article(s) in use is near end of life can, for example, be the trigger for a command to be sent to a ventilation system 1004A to increase ventilation in response to the higher dust production. Similarly, a setting for ventilation system 1004A may be reduced when an abrasive article is nearer to the beginning of its useful life. A trigger for changing the ventilation settings may be generated using any of the end-of-life detection methods herein, including detecting visual cues, detecting a change in temperature, detecting physical changes, or by examining swarf.

Similarly, it may be useful to know how used an abrasive article is—not for replacement, but for downstream repairs. Generally, abrasive operations start with the coarsest grade and work down to finer grades to polish a substrate surface. For example, first a 60 grit disc, then an 80 grit disc, before finally a 120 disc. However, if it is known that the 60 grit disc is near its end of life, it will not leave as many scratches, and the 80 grit abrading step may be skipped entirely, progressing directly to the 120 grit disc. While such a decision may be made by an experienced operator, similar guidance may be helpful for newer operators, and may increase efficiency of robotic abrading systems.

FIG. 10 specifically shows that a system 1010 can be located at a remote server location 1002. Therefore, computing device 1020 accesses those systems through remote server location 1002. Operator 1050 can use computing device 1020 to access user interfaces 1022 as well. For example, user interface 1022 may provide an indication of how worn an abrasive article is, changes that are made to any of networked systems 1004, or suggested changes to the operation by the operator—such as increasing force, increasing RPMs, etc.

FIG. 10 shows that it is also contemplated that some elements of systems described herein are disposed at remote server location 1002 while others are not. By way of example, storage 1030, 1040 or 1060 or robotic systems 1070 can be disposed at a location separate from location 1002 and accessed through the remote server at location 1002. Regardless of where they are located, they can be accessed directly by computing device 1020, through a network (either a wide area network or a local area network), hosted at a remote site by a service, provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers.

It will also be noted that the elements of systems described herein, or portions of them, can be disposed on a wide variety of different devices. Some of those devices include servers, desktop computers, laptop computers, imbedded computer, industrial controllers, tablet computers, or other mobile devices, such as palm top computers, cell phones, smart phones, multimedia players, personal digital assistants, etc.

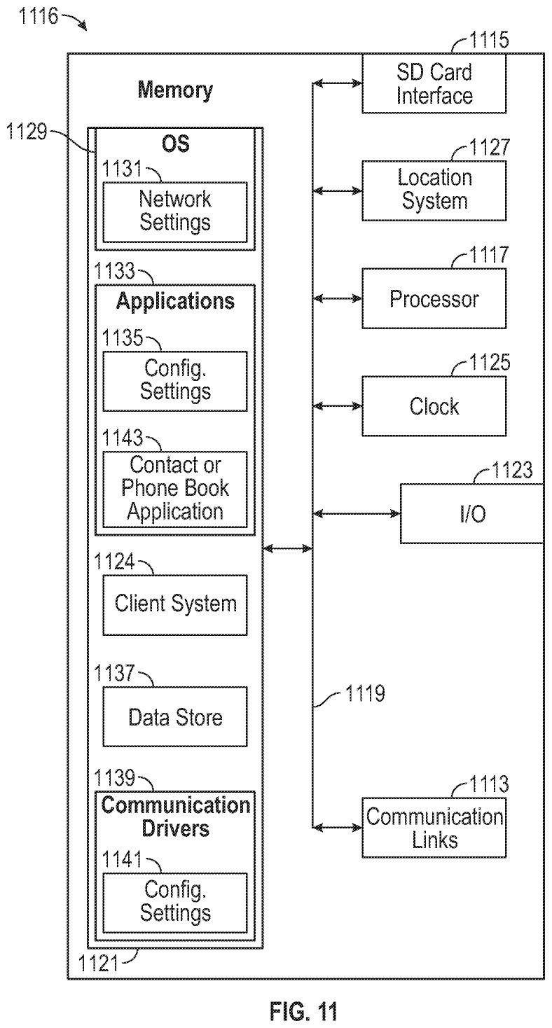

FIGS. 11-13 show examples of computing devices that can be used in embodiments shown in previous Figures.

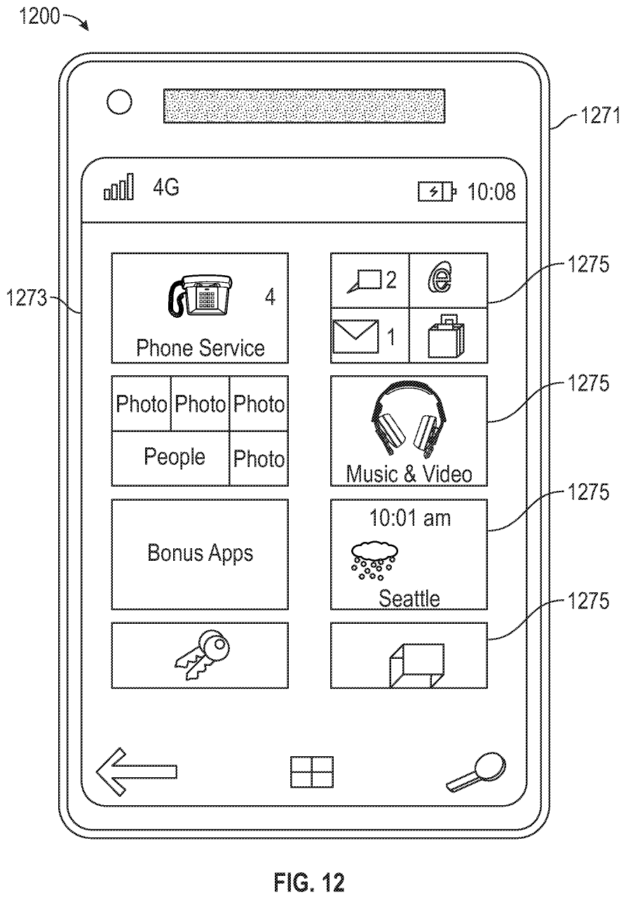

FIG. 11 is a simplified block diagram of one illustrative example of a handheld or mobile computing device that can be used as a user's or client's handheld device 1116 (e.g., as computing device 1020 in FIG. 10), in which the present system (or parts of it) can be deployed. For instance, a mobile device can be deployed in the operator compartment of computing device 1020 for use in generating, processing, or displaying the data. FIG. 12 is another example of a handheld or mobile device.

FIG. 11 provides a general block diagram of the components of a client device 1116 that can run some components shown and described herein. Client device 1116 interacts with them, or runs some and interacts with some. In the device 1116, a communications link 1113 is provided that allows the handheld device to communicate with other computing devices and under some embodiments provides a channel for receiving information automatically, such as by scanning. Examples of communications link 1113 include allowing communication though one or more communication protocols, such as wireless services used to provide cellular access to a network, as well as protocols that provide local wireless connections to networks.

In other examples, applications can be received on a suitable removable memory card (such as an Secure Digital (SD) card, CF card, microSD or portable hard drive) that is connected to an interface 1415. Interface 1115 and communication links 1113 communicate with a processor 1117 (which can also embody a processor) along a bus 1119 that is also connected to memory 1121 and input/output (I/O) components 1123, as well as clock 1125 and location system 1127.

I/O components 1123, in one embodiment, are provided to facilitate input and output operations and the device 1116 can include input components such as buttons, touch sensors, optical sensors, microphones, touch screens, proximity sensors, accelerometers, orientation sensors and output components such as a display device, a speaker, and or a printer port. Other I/O components 1123 can be used as well.

Clock 1125 illustratively comprises a real time clock component that outputs a time and date. It can also provide timing functions for processor 1117.

Illustratively, location system 1127 includes a component that outputs a current geographical location of device 1116. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 1121 stores operating system 1129, network settings 1131, applications 1133, application configuration settings 1135, data store 1137, communication drivers 1139, and communication configuration settings 1141. Memory 1121 can include all types of tangible volatile and non-volatile computer-readable memory devices. It can also include computer storage media (described below). Memory 1121 stores computer readable instructions that, when executed by processor 1117, cause the processor to perform computer-implemented steps or functions according to the instructions. Processor 1117 can be activated by other components to facilitate their functionality as well.

FIG. 12 shows that the device can be a smart phone 1201. Smart phone 1271 has a touch sensitive display 1273 that displays icons or tiles or other user input mechanisms 1275. Mechanisms 1275 can be used by a user to run applications, make calls, perform data transfer operations, etc. In general, smart phone 1271 is built on a mobile operating system and offers more advanced computing capability and connectivity than a feature phone.

Note that other forms of the devices 1216 are possible.

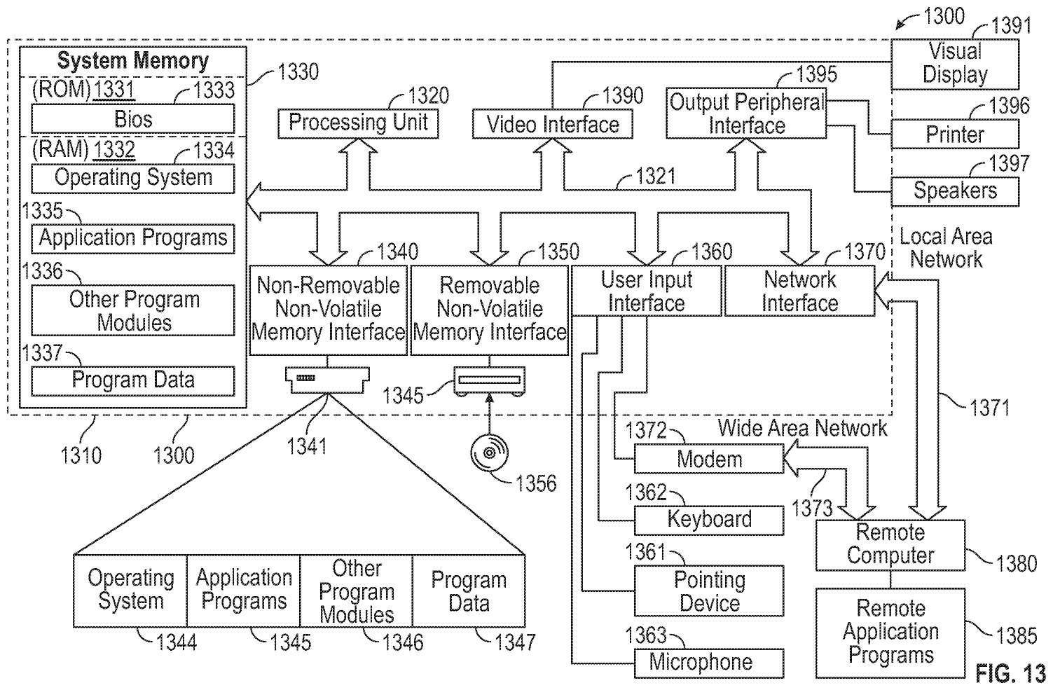

FIG. 13 is a block diagram of a computing environment that can be used in embodiments shown in previous Figures.

FIG. 13 is one example of a computing environment in which elements of systems and methods described herein, or parts of them (for example), can be deployed. With reference to FIG. 13, an example system for implementing some embodiments includes a general-purpose computing device in the form of a computer 1310. Components of computer 1310 may include, but are not limited to, a processing unit 1320 (which can comprise a processor), a system memory 1330, and a system bus 1321 that couples various system components including the system memory to the processing unit 1320. The system bus 1321 may be any of several types of bus structures including a memory bus or memory controller, a peripheral bus, and a local bus using any of a variety of bus architectures. Memory and programs described with respect to systems and methods described herein can be deployed in corresponding portions of FIG. 13.

Computer 1310 typically includes a variety of computer readable media. Computer readable media can be any available media that can be accessed by computer 1310 and includes both volatile/nonvolatile media and removable/non-removable media. By way of example, and not limitation, computer readable media may comprise computer storage media and communication media. Computer storage media is different from, and does not include, a modulated data signal or carrier wave. It includes hardware storage media including both volatile/nonvolatile and removable/non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1310. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1330 includes computer storage media in the form of volatile and/or nonvolatile memory such as read only memory (ROM) 1331 and random access memory (RAM) 1332. A basic input/output system 1333 (BIOS) containing the basic routines that help to transfer information between elements within computer 1310, such as during start-up, is typically stored in ROM 1331. RAM 1332 typically contains data and/or program modules that are immediately accessible to and/or presently being operated on by processing unit 1320. By way of example, and not limitation, FIG. 13 illustrates operating system 1334, application programs 1335, other program modules 1336, and program data 1337.

The computer 1310 may also include other removable/non-removable and volatile/nonvolatile computer storage media. By way of example only, FIG. 13 illustrates a hard disk drive 1341 that reads from or writes to non-removable, nonvolatile magnetic media, nonvolatile magnetic disk 1352, an optical disk drive 1355, and nonvolatile optical disk 1356. The hard disk drive 1341 is typically connected to the system bus 1321 through a non-removable memory interface such as interface 1340, and optical disk drive 1355 are typically connected to the system bus 1321 by a removable memory interface, such as interface 1350.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 13, provide storage of computer readable instructions, data structures, program modules and other data for the computer 1310. In FIG. 13, for example, hard disk drive 1341 is illustrated as storing operating system 1344, application programs 1345, other program modules 1346, and program data 1347. Note that these components can either be the same as or different from operating system 1334, application programs 1335, other program modules 1336, and program data 1337.

A user may enter commands and information into the computer 1310 through input devices such as a keyboard 1362, a microphone 1363, and a pointing device 1361, such as a mouse, trackball or touch pad. Other input devices (not shown) may include a joystick, game pad, satellite receiver, scanner, or the like. These and other input devices are often connected to the processing unit 1320 through a user input interface 1360 that is coupled to the system bus, but may be connected by other interface and bus structures. A visual display 1391 or other type of display device is also connected to the system bus 1321 via an interface, such as a video interface 1390. In addition to the monitor, computers may also include other peripheral output devices such as speakers 1397 and printer 1396, which may be connected through an output peripheral interface 1395.

The computer 1310 is operated in a networked environment using logical connections, such as a Local Area Network (LAN) or Wide Area Network (WAN) to one or more remote computers, such as a remote computer 1380.

When used in a LAN networking environment, the computer 1310 is connected to the LAN 1371 through a network interface or adapter 1370. When used in a WAN networking environment, the computer 1310 typically includes a modem 1372 or other means for establishing communications over the WAN 1373, such as the Internet. In a networked environment, program modules may be stored in a remote memory storage device. FIG. 13 illustrates, for example, that remote application programs 1385 can reside on remote computer 1380.

Objects and advantages of this disclosure are further illustrated by the following non-limiting examples, but the particular materials and amounts thereof recited in these examples, as well as other conditions and details, should not be construed to unduly limit this disclosure.

An abrasive article evaluation system is presented that includes a detector that detects a nonvisual abrasive wear cue and an efficiency indication generator that, based on the abrasive wear cue, generates an indication of wear for the abrasive article. The system also includes a command generator that generates a command based in the generated indication of wear.

The system may be implemented such that it also includes a parameter retriever that retrieves a current operational parameter for a tool associated with the abrasive article. The command generator generates a command to adjust the operational parameter from a first value to a second value, different from the first value.

The system may be implemented such that the operational parameter is an applied force, the tool is a robotic abrading unit and the second value is a higher applied force than a first applied force.

The system may be implemented such that the operation parameter is a speed, and a second speed is higher than a first speed.

The system may be implemented such that the command is a replacement command. A robotic abrading unit associated with the abrasive article initiates an abrasive article replacement sequence automatically, based on the command.

The system may be implemented such that the command is a downstream operation command that, based on the indication of wear, adjusts a downstream abrading operation parameter.

The system may be implemented such that the downstream abrading operation parameter is a speed, a force or a dwell time.

The system may be implemented such that the downstream abrading operation parameter is a second abrasive operation with a second abrasive article.

The system may be implemented such that it includes a historic value retriever that retrieves a historic value for the operational parameter.

The system may be implemented such that the detector detects the cue in response to a detection initiator, which generates a trigger to actuate the detector.

The system may be implemented such that the detection initiator generates the trigger periodically.

The system of claim 10, wherein the detection initiator generates the trigger in response to a manual input.

The system may be implemented such that the detection initiator generates the trigger before an abrading operation starts.

The system may be implemented such that the detection initiator generates the trigger at an end of an abrading operation.

The system may be implemented such that the command is a graphical user interface update command. The command is communicated to a device with a display, and the command causes the display to present an updated graphical user interface.

The system may be implemented such that it includes a command communicator that communicates the command to a second device.

The system may be implemented such that the second device is a robotic abrading unit.

The system may be implemented such that the second device is a ventilation system.

The system may be implemented such that the second device is a dust collection system.

The system may be implemented such that the detector includes an acoustic emission sensor.

The system may be implemented such that the detector includes a voltage meter or current meter.

The system may be implemented such that the detector includes a thermometer.

The system may be implemented such that the detector includes an accelerometer.

The system may be implemented such that the detector includes a force control unit of a robotic abrading system.

The system may be implemented such that the detector detects the wear cue when in proximity of the abrasive article.

The system may be implemented such that the detector detects the wear cue when in contact with the abrasive article.

The system may be implemented such that the detector includes electrodes that contact leads of the abrasive article.

A robotic abrading system is presented that includes an abrasive article including a wear cue detectable by a sensor, the abrasive article being configured to contact a substrate. The system also includes a robot arm configured to cause the abrasive article to contact the substrate. The system also includes a force control unit, on the robot arm. The force control unit urges the abrasive article into contact with the substrate. The system also includes a wear indication system that determines an amount of wear of the abrasive article based on the wear cue, and, based on the amount of wear, an operational parameter of the robotic abrading system is adjusted.

The robotic abrading system may be implemented such that the wear indication system further includes: an efficiency indication generator that generates an abrasive efficiency for the abrasive article, based on a signal from the sensor, and a command generator that generates a command to adjust the operational parameter.

The robotic abrading system may be implemented such that the sensor is mounted on the robotic arm.

The robotic abrading system may be implemented such that the sensor is mounted to a movement mechanism.

The robotic abrading system may be implemented such that the sensor is a sound emission sensor and wherein the sensor detects a change in emitted sound of the abrasive article.

The robotic abrading system may be implemented such that the sensor is a voltage meter or a current meter. The sensor detects a discontinuity in a conductive pathway that extends across a portion of the abrasive article.

The robotic abrading system may be implemented such that the sensor is a force control unit mounted on the robotic arm. The force control unit detects a change in abrading rhythm.

The robotic abrading system may be implemented such that the sensor is an accelerometer.

The robotic system may be implemented such that the operational parameter is an automatic shutdown.

The robotic system may be implemented such that the operational parameter is an applied force by the force control unit, a rotational speed of the abrasive article, or a dwell time of the abrasive article on the substrate.

The robotic system may be implemented such that the operational parameter is a position of the abrasive article relative to a substrate.

The robotic system may be implemented such that the operational parameter is a parameter for a future abrasive operation on the substrate.

The robotic system may be implemented such that the operational parameter is a parameter for a future abrasive operation using the abrasive article.

The robotic system may be implemented such that the detector actuates a detection sequence in response to a detection initiation command from a controller.

The robotic system may be implemented such that the controller sends the detection initiation command periodically.

The robotic system may be implemented such that the controller sends the detection initiation command at a start of, or at an end of, an abrading operation.

The robotic system may be implemented such that the controller generates the command to adjust the operation parameter.

The robotic system may be implemented such that the wear indication system includes a historic value retriever that retrieves a historic value of the wear cue, and a wear processor that determines an amount of wear based on the wear cue and the retrieved historical value.

The robotic system may be implemented such that the historic value is a last captured wear cue.

The robotic system may be implemented such that the historic value is an initial wear cue.

The system may be implemented such that the abrasive article is an abrasive disc or an abrasive belt.

The system may be implemented such that the abrasive article is a bonded abrasive article.

The system may be implemented such that the abrasive article is an abrasive wheel.

The system may be implemented such that the abrasive article is a nonwoven abrasive article.

A wear detector for an abrasive article is presented that includes a cue capture device that detects a change in the abrasive article during or after an abrading operation. The detector also includes an efficacy indication generator that receives the change and provides a wear indication based on the detected change. The detector also includes a wear communicator that communicates the detected wear cue to a second device.

The wear detector may be implemented such that the change is a change in emitted sound of the abrasive article contacting a substrate.

The wear detector may be implemented such that the change is a change in vibration of the abrasive article against the substrate.

The wear detector may be implemented such that the change is a change in measured voltage or measured current across a portion of the abrasive article.

The detector may be implemented such that it includes a motion mechanism that moves the cue capture device into position in response to a motion control command.

The detector may be implemented such that the motion control command is received from the second device.

The detector may be implemented such that it includes a historic value retriever that retrieves a historic wear indication for the abrasive article.

The detector may be implemented such that it includes a threshold retriever that retrieves a threshold for the efficacy generator.

The detector may be implemented such that it includes a parameter retriever that retrieves a set of operational parameters for the abrasive article, and the threshold is retrieved based on the set of operational parameters.

The detector may be implemented such that the second device includes a datastore that receives and stores the wear indication.

The detector may be implemented such that the wear communicator generates a wear alarm such that second device generates an alarm based on the received detected wear cue.

An abrasive article with a wear cue is presented that includes a bond matrix and a plurality of abrasive particles within the bond matrix. The article also includes a detectable wear indicator that changes after a portion of the service life of the abrasive article has passed.

The abrasive article may be implemented such that the wear indicator is a sound emitted by the abrasive article when in contact with a substrate.

The abrasive article may be implemented such that the emitted sound includes the abrasive particles contacting the substrate, and the emitted sound changes from a first sound to a second sound as the abrasive article is worn down.

The abrasive article may be implemented such that the sound emitted is a first sound emitted by a first set of abrasive particles, and a second sound is generated after the portion of the service life has passed. The second sound is generated by a second material.

The abrasive article may be implemented such that the second material includes metal particles.

The abrasive article may be implemented such that the second material burnishes the metal substrate.

The abrasive article may be implemented such that the second material increases a reflectivity of the workpiece.

The abrasive article may be implemented such that the abrasive article includes a conductive pathway extending through a portion of the abrasive article, and wherein the conductive pathway is disrupted after the portion of the service life, and the detectable wear indicator is a discontinuity.

The abrasive article may be implemented such that the wear indicator includes a rapid change in measured voltage or current across the wire.

The abrasive article may be implemented such that the wire is a first wire, and the abrasive article includes a second wire extending through a second portion of the abrasive article.

The abrasive article may be implemented such that the first and second wires are parallel.

The abrasive article may be implemented such that the first and second wires do not intersect.

The abrasive article may be implemented such that the first and second wires intersect.

The abrasive article may be implemented such that the abrasive article includes a core, and wherein the surface includes a feature extending from a cylindrical shape.

The abrasive article may be implemented such that the feature is exposed during an abrading operation before the cylindrical shape.

The abrasive article may be implemented such that the feature imparts a density difference in the abrasive article adjacent the feature.

The abrasive article may be implemented such that the feature includes a semi-circle, semi-oval, sinusoidal curve, triangular, square, rectangle, polygon, or arc.

The abrasive article may be implemented such that the feature is a first feature, and wherein the surface includes a plurality of features.

The abrasive article may be implemented such that the plurality of features include an odd number of features.

The abrasive article may be implemented such that the plurality of features include an even number of features.

The abrasive article may be implemented such that the first feature includes a first shape, and a second feature includes a second shape, different from the first shape.

The abrasive article may be implemented such that the first shape has a first height relative to the cylindrical shape, the second shape has a second height relative to the cylindrical shape, and the first height differs from the second height.

The abrasive article may be implemented such that the abrasive article includes a scrim or backing layer with raised features.

The abrasive article may be implemented such that the features are embossed.

The abrasive article may be implemented such that the abrasive article is a bonded abrasive article, and the bond matrix is a resin, polymer, or vitreous bond.

The abrasive article may be implemented such that the abrasive article includes a backing, and the abrasive particles are coupled to the backing by the bond matrix.

The abrasive article may be implemented such that the backing is a nonwoven backing.

A method of evaluating an abrasive article is presented that includes abrading a substrate with the abrasive article and detecting a change in an output of the abrasive article while the abrasive article is in contact with the substrate, using a sensor. The method also includes evaluating a signal from the sensor, using an efficacy evaluator, and generating a wear indication based on the sensor signal. The method also includes communicating the wear indication to a device. The method also includes comparing the sensor signal to a first sensor signal, captured earlier in time than the sensor signal. The method also includes detecting that the sensor signal is significantly different from the first signal. The method also includes generating an alarm.

The method may be implemented such that the device includes a datastore.

The method may be implemented such that the device includes a display component.

The method may be implemented such that it includes generating an operational parameter change and communicating the operational parameter change to a robotic abrading unit coupled to the abrasive article.

The method may be implemented such that it includes estimating a remaining service life based on the wear indication.

The method may be implemented such that the remaining service life indication is estimated based on historic wear trends for the abrasive article.

The method may be implemented such that the remaining service life indication is estimated based on current operational parameters.

The method may be implemented such that the remaining service life indication is based on projected operational parameters.

The method may be implemented such that the sensor signal is a sound, and the wear indication is based on a change in the sound signal from an initial sound signal.

The method may be implemented such that the sensor signal is a sound, and the wear indication is based on an analysis of the sound, comparing the sound to a datastore of sounds correlated with known wear amounts of the abrasive article.

The method may be implemented such that the sensor signal is a voltage or current reading, and the wear indication is based on a detected discontinuity in a wire extending through a portion of the abrasive article.

The method may be implemented such that the sensor signal is a change in abrading rhythm of the abrasive article against the substrate.

A method of forming an abrasive article is presented that includes providing a plurality of abrasive particles, a bond matrix precursor, and a backing material and incorporating a wear indicator into any of: the abrasive particles, the bond matrix precursor or a backing. The method also includes embedding the abrasive particles within the bond matrix precursor. The method also includes curing the bond matrix precursor to form the abrasive article.

The method may be implemented such that the wear indicator is not detectable prior to a first abrasive operation using the abrasive article.

The method may be implemented such that the abrasive article is a bonded abrasive article, and wherein the backing material is a scrim layer.

The method may be implemented such that the backing material is a nonwoven material.

The method may be implemented such that the bond matrix precursor is a resin bond precursor, a vitreous bond precursor or a polymer bond precursor.

The method may be implemented such that the wear indicator includes a filler material that generates a detectable sound when the filler material contacts a substrate.

The method may be implemented such that the wear indicator includes a conductive pathway extending through a portion of the abrasive article.

The method may be implemented such that the wire extends through a portion of the backing.

The method may be implemented such that the wire extends through the abrasive article in a layer of the bond matrix.

The method may be implemented such that the wire extends through the abrasive article at an interface between the backing and the bond matrix precursor.

The method may be implemented such that the abrasive article also includes a core with a surface that bonds to the bond matrix, and wherein the wear indicator includes a feature on the surface.

The method may be implemented such that the feature is a tab that extends from the abrasive article, when exposed, and wherein the tab makes a detectable sound when it strikes a substrate.

The method may be implemented such that the feature includes a protrusion from the core.

The method may be implemented such that the protrusion includes a polygonal shape, a sinusoidal shape, a curved shape, a semicircular shape or a semi-ovular shape.

### EXAMPLES

### Example 1: Vibration in Convolute Wheel

### Vibration Core Preparation

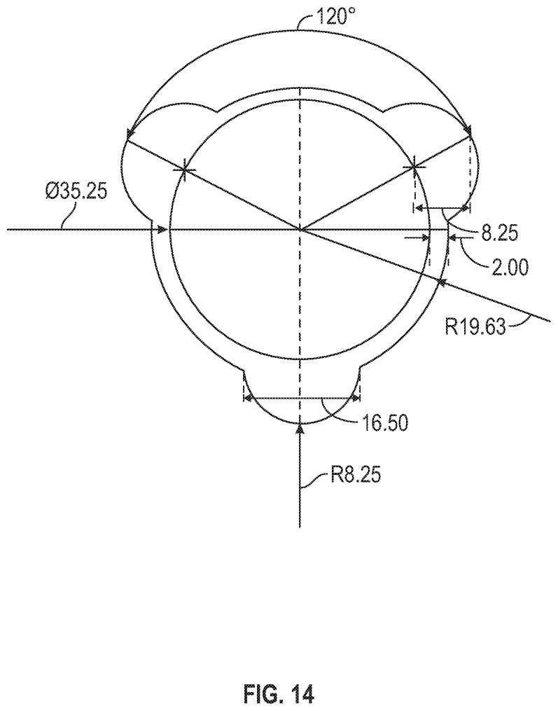

2 core sleeves featuring 3 protrusions were printed with ABS resin via a 3D printer (Fortus 450, Stratasys, Eden Prairie, Minnesota) machine. Length of the sleeves was 12 inches (304.8 mm) and the cross-section geometry (in millimeters) of the core sleeves shown in FIG. 14.

The sleeves were aligned and adhered to a standard fiberglass core with outer diameter 1.39 inch (35.3 mm), inner diameter 1 inch (25.4 mm), and length 24 inches (609.6 mm) using epoxy resin (DP100, 3M Company, Saint Paul, Minnesota).

### Example 1

A convolute bun was prepared to the exact specifications as used in making the commercially available wheel “GP Plus 8SF” from 3M Company, St. Paul, MN with the exception the core shown in Figure AA was used. Wheels of 0.5 inch (12.7 mm) and 1 inch (25.4 mm) thicknesses were used.

### Comparative Example A

A commercially available wheel under the name “GP Plus 8SF” from 3M Company, St. Paul, MN was obtained which had dimensions of 0.5 inch (12.7 mm) and 1 inch (25.4 mm).

### Density Measurements

Uniform cylindrical slugs of dimensions 7.7 mm diameter by 12.7 mm were punched out of the 0.5 inch (12.7 mm) thickness Example 1 wheels. 6 slugs in total were punched out, with their centerlines all approximately 28.1 mm distance from the center. 3 of the slugs were taken directly over the sleeve protrusions and 3 of the slugs were taken directly over the valleys between the protrusions. The slugs were weighed and the average densities are listed below in Table 1.

TABLE 1

| Average density of slugs | Average density of slugs |
|---|---|
| adjacent to valleys | adjacent to protrusions |
| 0.85 g/cm³ | 1.13 g/cm³ |

### Vibration Testing

1 inch thickness wheels from both Example 1 and Comparative Example A were mounted on an electric buffer (Baldor 412B 1.5 HP electric buffer, ABB Motors and Mechanicals Inc, Fort Smith, Arkansas) and run at 1750 rpm. An operator plunged a 1″×1″ steel bar into the face of the wheels. No differences were noted.

1 inch thickness wheels from both Example 1 and Comparative Example A were dressed down to 3 inch diameter to simulate heavy wear. Both wheels were mounted on an electric buffer (Baldor 412B 1.5 HP electric buffer, ABB Motors and Mechanicals Inc, Fort Smith, Arkansas) and run at 1750 rpm. An operator plunged a 1″×1″ steel bar into the face of the wheels. It was noted that the wheel from Example 1 showed significant vibration when compared to Comparative Example A.

1. An abrasive article evaluation system comprising:
a detector that detects a nonvisual abrasive wear cue;
an efficiency indication generator that, based on the abrasive wear cue, generates an indication of wear for the abrasive article;
a command generator that generates a command based in the generated indication of wear; and
a parameter retriever that retrieves a current operational parameter for a tool associated with the abrasive article,
wherein the command generator generates a command to adjust the operational parameter from a first value to a second value, different from the first value.

2. (canceled)

3. The system of claim 1, wherein the operational parameter is an applied force, the tool is a robotic abrading unit and the second value is a higher applied force than a first applied force.

4. The system of claim 1, wherein the operation parameter is a speed, and wherein a second speed is higher than a first speed.

5. The system of claim 1, wherein the command is a replacement command and wherein a robotic abrading unit associated with the abrasive article initiates an abrasive article replacement sequence automatically, based on the command.

6. The system of claim 1, wherein the command is a downstream operation command that, based on the indication of wear, adjusts a downstream abrading operation parameter wherein the downstream abrading operation parameter is a speed, a force or a dwell time, or a second abrasive operation with a second abrasive article.

7. The system of claim 1 further comprising:
a historic value retriever that retrieves a historic value for the operational parameter.

8. The system of claim 1, wherein the command is a graphical user interface update command, and wherein the command is communicated to a device with a display, and wherein the command causes the display to present an updated graphical user interface.

9. The system of claim 1 further comprising:
a command communicator that communicates the command to a second device.

10. The system of claim 1, wherein the detector comprises an acoustic emission sensor.

11. The system of claim 1, wherein the detector comprises a voltage meter or current meter.

12. The system of claim 1, wherein the detector comprises a thermometer.

13. The system of claim 1, wherein the detector comprises an accelerometer.

14. The system of claim 1, wherein the detector detects the wear cue when in proximity of the abrasive article.

15. The system of claim 14, wherein the detector detects the wear cue when in contact with the abrasive article.

16. A robotic abrading system comprising:
an abrasive article comprising a wear cue detectable by a sensor, the abrasive article being configured to contact a substrate;
a robot arm configured to cause the abrasive article to contact the substrate;
a force control unit, on the robot arm, wherein the force control unit urges the abrasive article into contact with the substrate; and
a wear indication system that determines an amount of wear of the abrasive article based on the wear cue, and, based on the amount of wear, an operational parameter of the robotic abrading system is adjusted.

17. The robotic abrading system of claim 16, wherein the wear indication system further comprises:
an efficiency indication generator that generates an abrasive efficiency for the abrasive article; based on a signal from the sensor; and
a command generator that generates a command to adjust the operational parameter.

18. The robotic abrading system of claim 16, wherein the sensor is a sound emission sensor and wherein the sensor detects a change in emitted sound of the abrasive article.

19. The robotic abrading system of claim 16, wherein the sensor is a voltage meter or a current meter, and wherein the sensor detects a discontinuity in a conductive pathway that extends across a portion of the abrasive article.

20. The robotic abrading system of claim 16, wherein the sensor is a force control unit mounted on the robotic arm, and wherein the force control unit detects a change in abrading rhythm.

21. The robotic system of any claim 16, wherein the operational parameter is an automatic shutdown.

22. The robotic system of claim 16, wherein the operational parameter is an applied force by the force control unit, a rotational speed of the abrasive article, or a dwell time of the abrasive article on the substrate.

23. The robotic system of claim 16, wherein the operational parameter is a parameter for a future abrasive operation using the abrasive article.

24. The robotic system of claim 16, wherein the detector actuates a detection sequence in response to a detection initiation command from a controller.

25. The robotic system of claim 24, wherein the controller generates the command to adjust the operation parameter.

26. The robotic system of claim 16, wherein the wear indication system comprises a historic value retriever that retrieves a historic value of the wear cue, and a wear processor that determines an amount of wear based on the wear cue and the retrieved historical value.

27. The robotic system of claim 26, wherein the historic value is a last captured wear cue.

28. The robotic system of claim 26, wherein the historic value is an initial wear cue.

29. A wear detector for an abrasive article comprising:
a cue capture device that detects a change in the abrasive article during or after an abrading operation;
an efficacy indication generator that receives the change and provides a wear indication based on the detected change; and
a wear communicator that communicates the detected wear cue to a second device.

30. The wear detector of claim 29, wherein the change is a change in emitted sound of the abrasive article contacting a substrate.

31. The wear detector of claim 29, wherein the change is a change in vibration of the abrasive article against the substrate.

32. The wear detector of claim 29, wherein the change is a change in measured voltage or measured current across a portion of the abrasive article.

33. The detector of claim 29 further comprising:
a motion mechanism that moves the cue capture device into position in response to a motion control command.

34. The detector of claim 30, wherein the motion control command is received from the second device.

35. The detector of claim 29 further comprising:
a historic value retriever that retrieves a historic wear indication for the abrasive article.

36. The detector of claim 29 further comprising:
a threshold retriever that retrieves a threshold for the efficacy generator.

37. The detector of claim 36 further comprising:
a parameter retriever that retrieves a set of operational parameters for the abrasive article, and wherein the threshold is retrieved based on the set of operational parameters.

38. The detector of claim 29, wherein the second device comprises a datastore that receives and stores the wear indication.

39. The detector of claim 29, wherein the wear communicator generates a wear alarm such that second device generates an alarm based on the received detected wear cue.
